(19) United States
(12) Patent Application Publication
(10) Pub. No.: US 2019/0107249 A1
(43) Pub. Date: Apr. 11, 2019

(54) LUBRICATION GUN

(71) Applicant: Borislav Jolic, Ridgewood, NY (US)

(72) Inventor: Borislav Jolic, Ridgewood, NY (US)

(21) Appl. No.: 15/909,620

(22) Filed: Mar. 1, 2018

Related U.S. Application Data
(60) Provisional application No. 62/568,503, filed on Oct. 5, 2017.

(51) Int. Cl. F16N 3/12; F16N 11/08; F16N 21/00

(52) U.S. Cl. CPC F16N 3/12; G06K 2019/06253; F16N 21/00; F16N 11/08

(57) ABSTRACT

A lubrication gun including a housing having a nozzle fluidly connected with a lubrication tube connection port. The lubrication tube connection port is operable to receive and secure a tube of lubrication. A computer is disposed within the housing. The computer includes a processor and a memory. A hose includes a first end having a first connector and a second end having a second connector. The first connector is releasably secured to the nozzle of the housing. A tube coupler is releasably secured to the second connector. The tube coupler includes a data reader configured to send data to the computer.

### CROSS-REFERENCE TO RELATED APPLICATION

This application claims the benefit of priority of U.S. provisional application No. 62/568,503, filed Oct. 5, 2017, the contents of which are herein incorporated by reference.

### BACKGROUND OF THE INVENTION

The present invention relates to lubricating mechanical devices and, more particularly, to a lubrication gun that determines when a mechanical device has been lubricated, what type of lubrication is required and how much lubrication is required.

A lubrication gun is a common workshop and garage tool used for lubrication. The purpose of the lubrication gun is to apply lubricant through an aperture to a specific point, usually on a lubrication fitting or ‘nipple’. The lubrication fitting is a metal fitting used in mechanical devices to feed lubricants, usually lubricating lubrication, into a bearing under moderate to high pressure using the lubrication gun. The mechanical devices need to be lubricated on a set schedule. Otherwise, the mechanical devices may fail. Further, each of the mechanical devices require a certain type of lubricant and a certain amount of lubricant to continue to function properly.

As can be seen, there is a need for a lubrication gun that determines when a mechanical device has been lubricated, what type of lubrication is required and how much lubrication is required.

### SUMMARY OF THE INVENTION

In one aspect of the present invention, a lubrication gun comprises: a housing comprising a nozzle fluidly connected with a lubrication tube connection port, wherein the lubrication tube connection port is operable to receive and secure a tube of lubrication; a computer disposed within the housing, the computer comprising a processor and a memory; a hose comprising a first end comprising a first connector connected to the nozzle and a second end comprising a second connector; and a tube coupler connected to the second connector, the tube coupler comprising a data reader configured to send data to the computer.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is an exploded detail view of an embodiment of the present invention;

FIG. 3 is an exploded detail view of an embodiment of the present invention;

FIG. 4 is a front detail view of an embodiment of the present invention;

FIG. 5 is an exploded view of an embodiment of the present invention;

FIG. 6 is a perspective view of an embodiment of the present invention;

FIG. 7 is a perspective view of an embodiment of the present invention;

FIG. 8 is a perspective view of an embodiment of the present invention; and

FIG. 9 is a perspective view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

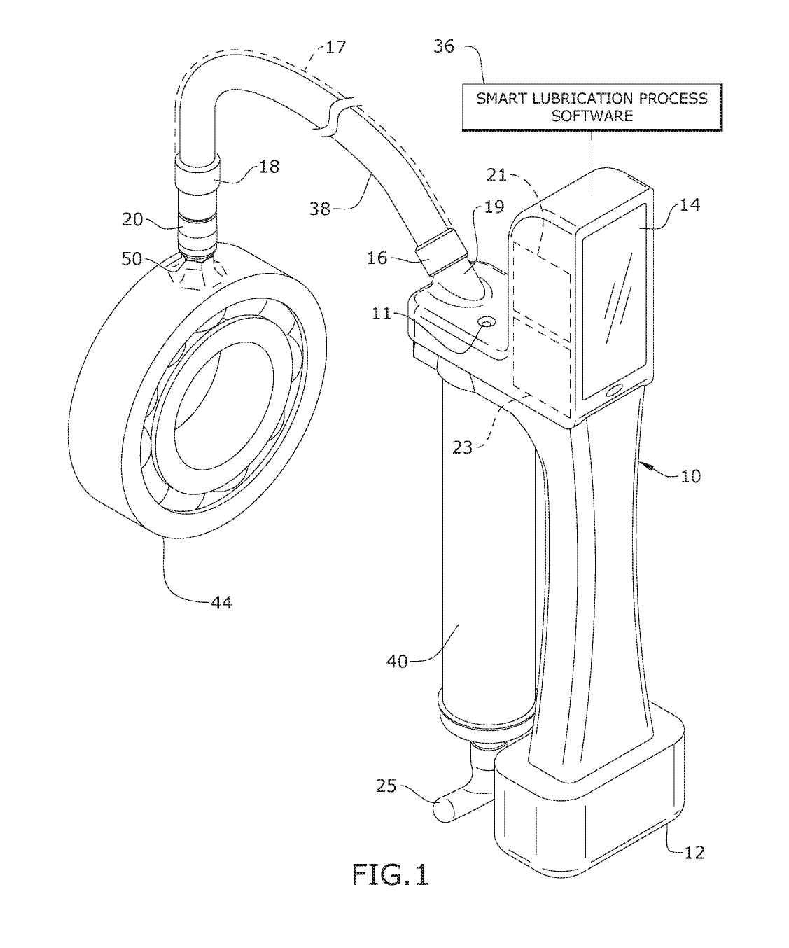

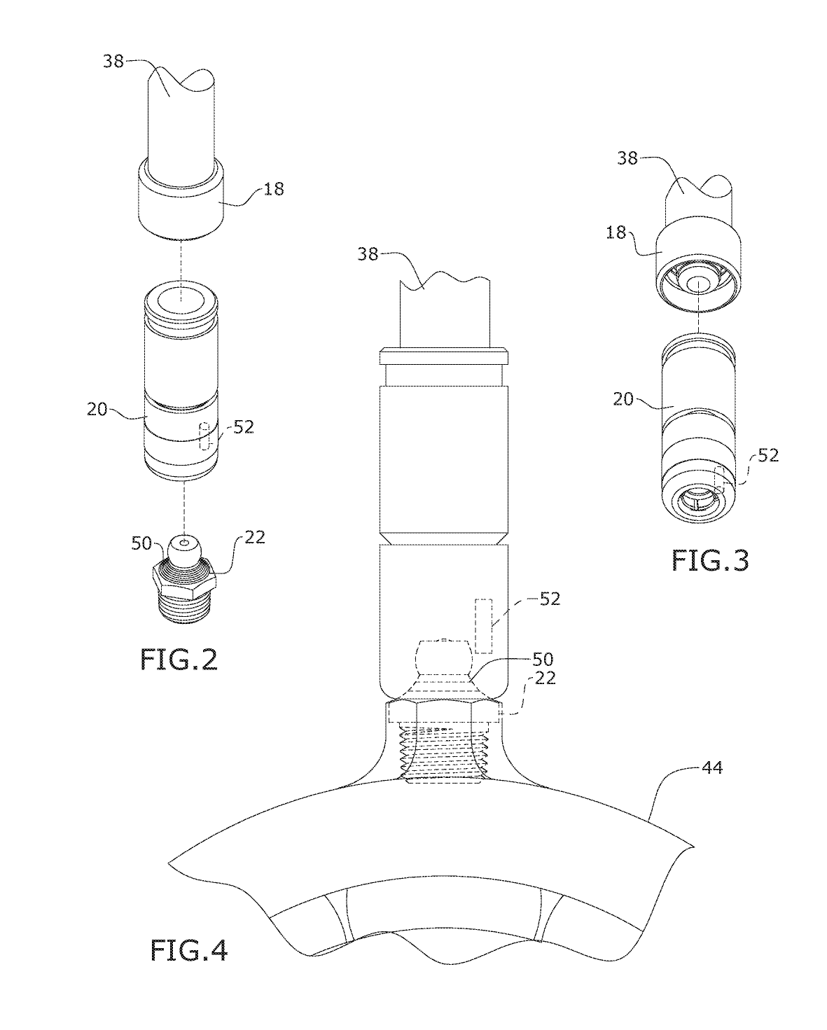

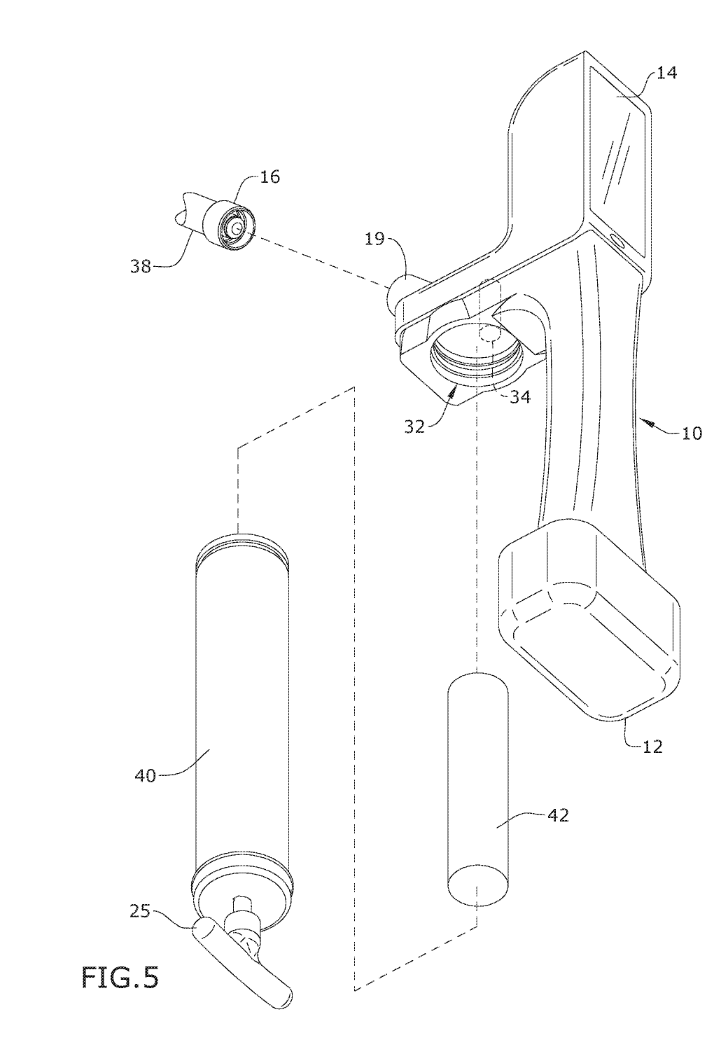

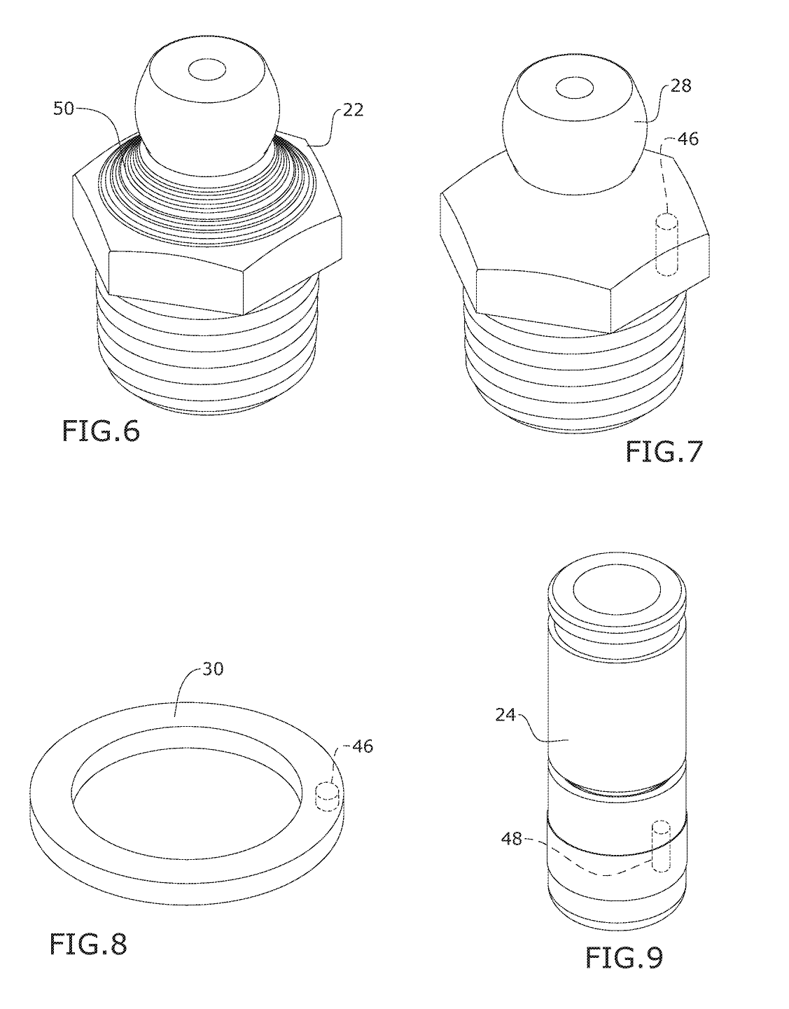

Referring to FIGS. 1 through 9, the present invention includes a lubrication gun. The lubrication gun includes a housing 10. The housing 10 includes a nozzle 19 fluidly connected with a lubrication tube connection port 32. The lubrication tube connection port 32 is operable to receive and secure a tube of lubrication 40. A computer 21 is disposed within the housing 10. The computer 21 includes a processor and a memory. A hose 38 includes a first end having a first connector 16 and a second end having a second connector 18. The first connector 16 is releasably secured to the nozzle 19 of the housing 10. A tube coupler 20, 24 is releasably secured to the second connector 18. The tube coupler 20, 24 includes a data reader 52, 48 configured to send data to the computer 21.

The lubrication gun of the present invention may be a manual lubrication gun with a manual pump 25. Alternatively, the lubrication gun may be an automatic lubrication gun in which a battery 12 powers a motor 23 that pumps the lubrication from the tube of lubrication 40 and through the nozzle 19. The housing 10 of the lubrication gun may further include a lubrication refill port 11. The lubrication refill port 11 is fluidly connected with the lubrication tube connection port 32 and includes a valve. The lubrication refill port 11 may be used to refill the tube of lubrication 40 with lubrication. Alternatively, the tube of lubrication 40 may be removed from the lubrication tube connection port 32 and a new lubrication refill 42 may be placed within the tube of lubrication 40.

In certain embodiments, an electrical circuit 17 is formed in the hose 38 running from the first connector 16 to the second connector 18. For example, the first connector 16 and the second connector 18 may each be electromechanical quick connectors and an electrical wire may run through the hose 38 from the first connector 16 to the second connector 18. In such embodiments, the data retrieved from the data reader 52, 48 is sent from the tube coupler 20, 24, through the hose 38 and to the computer 21.

The present invention further includes a lubrication fitting 22, 28 coupled to a mechanical device 44, such as a bearing. The lubrication fitting 22, 28 includes the data in a computer readable form. The data includes at least one of an identifier of the mechanical device 44, a type of lubrication used for the mechanical device 44, and an amount of lubrication needed for the mechanical device 44. In certain embodiments, the housing 10 may include a screen display 14, such as a touchscreen interface. The computer 21 may display the data on the screen display 14.

In certain embodiments, the data reader 52, 48 is a scanner 52 and the data is printed or engraved on the lubrication fitting 22 as a barcode 50. In certain embodiments, the data reader 52, 48 is a radio-frequency identification (RFID) reader 48 and the data is stored in an RFID carrier 46 disposed within the lubrication fitting 28. In such embodiments, the RFID reader 48 and RFID carrier 46 may be near field communication (NFC) devices. In certain embodiments, the RFID carrier 46 is disposed within a washer 30 as opposed to the lubrication fitting 28. The washer 30 may be disposed in between the mechanical device 44 and the lubrication fitting 28, in range of the RFID reader 48 of the tube coupler 24.

In certain embodiments, the present invention may include a lubrication tube data reader 34. The lubrication tube data reader 34 may be secured to the housing 10 and may be a scanner. The lubrication tube data reader 34 is operatively connected to the computer 21. The lubrication tube data reader 34 may read a barcode disposed on the lubrication refill 42. The barcode may include data such as the type of lubrication within the lubrication refill 42. If the type of lubrication within the lubrication refill 42 does not match the type of lubrication used for the mechanical device 44 sent from the lubrication fitting 22, 28, a notification is produced on the screen display 14. The computer 21 includes at least a processor and a memory. The computer 21 may execute on any suitable operating system such as IBM's zSeries/Operating System (z/OS), MS-DOS, PC-DOS, APPLE OS, APPLE iOS, APPLE WATCH OS, WINDOWS, UNIX, OpenVMS, ANDROID, an operating system based on LINUX, or any other appropriate operating system, including future operating systems.

In particular embodiments, the computer 21 includes a processor, memory, a user interface, and a communication interface. In particular embodiments, the processor includes hardware for executing instructions, such as those making up a computer program 36. The memory includes main memory for storing instructions such as the computer program 36 for the processor to execute, or data for processor to operate on. The memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to the computer, where appropriate. In particular embodiments, the memory is non-volatile, solid-state memory.

The user interface includes hardware, software, or both providing one or more interfaces for user communication with the computer. As an example and not by way of limitation, the user interface may include a keyboard, keypad, microphone, monitor, mouse, printer, scanner, speaker, still camera, stylus, tablet, touchscreen, trackball, video camera, another user interface or a combination of two or more of these.

The communication interface includes hardware, software, or both providing one or more interfaces for communication (e.g., packet-based communication) between the computer and a remote server. As an example, and not by way of limitation, communication interface may include a network interface controller (NIC) or network adapter for communicating with an Ethernet or other wire-based network or a wireless NIC (WNIC) or wireless adapter for communicating with a wireless network, such as a WI-Fl network. This disclosure contemplates any suitable network and any suitable communication interface. As an example, and not by way of limitation, the computer may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computer may communicate with a wireless PAN (WPAN) (e.g., a BLUETOOTH WPAN), a WI-Fl network, a WI-MAX network, a cellular telephone network (e.g., a Global System for Mobile Communications (GSM) network), or other suitable wireless network or a combination of two or more of these. The computer may include any suitable communication interface for any of these networks, where appropriate.

The processor of the computer 21 performs steps. For example, the processor receives the data including the identifier of the mechanical device 44. The processor then searches a database for a log of passed occurrences of lubricating of the mechanical device 44 using the identifier. The database may be part of the computer's memory. Alternatively, the computer 21 may wirelessly communicate with a remote server using the communications interface to search a remote database. Once the log has been retrieved, the processor displays the log on the screen display 14. Further, the processor receives the data including the type of lubrication and the amount of lubrication and displays the type of lubrication and the amount of lubrication on the screen display 14. When the lubrication is pumped into the mechanical device 44, the processor may create a new log and save it to the database. The log may include the identifier, the date and the time the lubrication was pumped into the mechanical device 44.

It should be understood, of course, that the foregoing relates to exemplary embodiments of the invention and that modifications may be made without departing from the spirit and scope of the invention as set forth in the following claims.

What is claimed is:

1. A lubrication gun comprising:
a housing comprising a nozzle fluidly connected with a lubrication tube connection port, wherein the lubrication tube connection port is operable to receive and secure a tube of lubrication;
a pump configured to pump lubrication from the tube of lubrication out of the nozzle;
a computer disposed within the housing, the computer comprising a processor and a memory;
a hose comprising a first end comprising a first connector connected to the nozzle and a second end comprising a second connector; and
a tube coupler connected to the second connector, the tube coupler comprising a data reader configured to send data to the computer.

2. The lubrication gun of claim 1, wherein an electrical circuit is formed in the hose from the first connector to the second connector, wherein the data is sent through the hose to the computer.

3. The lubrication gun of claim 1, further comprising a lubrication fitting coupled to a mechanical device, the lubrication fitting comprising the data, wherein the tube coupler is configured to connect with the lubrication fitting.

4. The lubrication gun of claim 3, wherein the data reader is a scanner and the data is printed or engraved on the lubrication fitting as a barcode.

5. The lubrication gun of claim 3, wherein the data reader is a radio-frequency identification (RFID) reader and the data is stored in an RFID carrier disposed within the lubrication fitting.

6. The lubrication gun of claim 3, wherein the data comprises at least one of an identifier of the mechanical device, a type of lubrication used for the mechanical device, and an amount of lubrication needed for the mechanical device.

7. The lubrication gun of claim 6, wherein the housing further comprises a screen display operatively connected to the computer.

8. The lubrication gun of claim 7, wherein the processor
receives the data comprising the identifier of the mechanical device;
searches a database for a log of passed occurrences of greasing of the mechanical device using the identifier; and
displays the log on the screen display.

9. The lubrication gun of claim 7, wherein the processor
receives the data comprising the type of lubrication and the amount of lubrication; and
displays the type of lubrication and the amount of lubrication on the screen display.

10. The lubrication gun of claim 1, further comprising a motor and a battery disposed within the housing, wherein the motor is operably connected to the pump.
